(19) United States
(12) Patent Application Publication
(10) Pub. No.: US 2026/0322048 A1
(43) Pub. Date: Oct. 15, 2026

(54) ELECTRICAL CONNECTOR

(71) Applicant: BIZLINK INTERNATIONAL CORP., New Taipei City (TW)

(72) Inventors: Hongping SU, New Taipei City (TW); Haoran ZOU, New Taipei City (TW)

(21) Appl. No.: 19/642,593

(22) Filed: Apr. 8, 2026

(30) Foreign Application Priority Data
Apr. 11, 2025 (CN) 202520687810.2

(51) Int. Cl. H01R 24/22; H01R 13/11; H01R 4/02; H01R 4/06; H01R 4/56; H01R 13/03

(52) U.S. Cl. CPC H01R 24/22; H01R 13/113; H01R 4/023; H01R 4/029; H01R 4/06; H01R 4/56; H01R 13/03

(57) ABSTRACT

An electrical connector for providing power to a server includes a positive module and a negative module spaced apart along a lateral direction. The positive module includes a pair of positive terminal groups, a first positive busbar, and a second positive busbar. The first positive busbar has a first sandwiched portion disposed between the positive terminal groups and a first extending portion extending along the lateral direction towards a first side. The second positive busbar has a second sandwiched portion disposed between the positive terminal groups and a second extending portion extending along the lateral direction towards an opposite second side. The first and second sandwiched portions are spaced apart along a longitudinal direction perpendicular to the lateral direction.

### CROSS - REFERENCE TO RELATED APPLCATION

This application claims priority to China Application Serial Number 202520687810.2, filed Apr. 11, 2025, which is herein incorporated by reference in its entirety.

### BACKGROUND

### Field of Invention

The present disclosure relates generally to the field of connector technology, and more particularly to an electrical connector for providing power to a server.

### Description of Related Art

Electrical connectors are typically used to distribute main power to server cabinets. Conventional electrical connectors for servers usually have only one pair of terminal modules, wherein one terminal module is used for a positive connection and the other terminal module is used for a negative connection. However, such conventional electrical connectors cannot carry large currents, which can easily cause failures and burnout of the electrical connectors.

Therefore, there is a need for an improved electrical connector capable of carrying larger currents while maintaining a reliable structure to overcome the aforementioned deficiencies.

### SUMMARY

The present disclosure relates to an electrical connector with a simple structure having separated positive and negative modules, which is capable of carrying a larger current.

In one aspect, the present disclosure provides an electrical connector for providing power to a server, including a positive module and a negative module spaced apart from each other along a lateral direction. The positive module includes a pair of positive terminal groups spaced apart from each other along the lateral direction. A first positive busbar includes a first sandwiched portion disposed between the pair of positive terminal groups, and a first extending portion extending along the lateral direction towards a first side of the electrical connector. A second positive busbar includes a second sandwiched portion disposed between the pair of positive terminal groups, and a second extending portion extending along the lateral direction towards a second side opposite to the first side. The first sandwiched portion and the second sandwiched portion are spaced apart from each other along a longitudinal direction perpendicular to the lateral direction. The negative module includes a pair of negative terminal groups spaced apart from each other along the lateral direction.

In another aspect, the present disclosure provides an electrical connector for providing power to a server, including at least one module. The at least one module includes a pair of terminal groups spaced apart from each other along a lateral direction. A first conductive busbar includes a first sandwiched portion disposed between the pair of terminal groups, and a first extending portion extending along the lateral direction towards a first side of the electrical connector. A second conductive busbar includes a second sandwiched portion disposed between the pair of terminal groups, and a second extending portion extending along the lateral direction towards a second side opposite to the first side. The first sandwiched portion and the second sandwiched portion are spaced apart from each other between the pair of terminal groups along a longitudinal direction, wherein the longitudinal direction is perpendicular to the lateral direction.

By adopting the aforementioned structures, the electrical connector of the present disclosure is capable of achieving several beneficial technical effects in some embodiments. The provision of two spaced terminal groups is intended to facilitate carrying a relatively larger current. The spaced arrangement of the sandwiched portions is configured to potentially reduce the risk of short circuits. Furthermore, sandwiching two busbars side-by-side between the two terminal groups may provide low impedance and low temperature rise. Additionally, the structure facilitates simplified processing and assembly, which may reduce manufacturing costs. Lastly, the extending portions extending in opposite directions are staggered in the lateral direction, which is configured to be consistent with a PDB (Power Distribution Board) outgoing line arrangement, thereby potentially making the wiring process much more convenient.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is a perspective view of an electrical connector according to an embodiment of the present disclosure;

FIG. 2 is a perspective view showing a positive module and a negative module of the electrical connector according to an embodiment of the present disclosure;

FIG. 3 is another perspective view of the positive module and the negative module of FIG. 2, shown in a laying-down position to illustrate the components from a different angle;

FIG. 4A is a perspective view of a first positive busbar of the electrical connector according to an embodiment of the present disclosure;

FIG. 4B is a perspective view of a second positive busbar of the electrical connector according to an embodiment of the present disclosure;

FIG. 4C is a perspective view of a first negative busbar of the electrical connector according to an embodiment of the present disclosure;

FIG. 4D is a perspective view of a second negative busbar of the electrical connector according to an embodiment of the present disclosure; and

FIG. 5 is a perspective view showing the electrical connector connected to external electrical wires according to an embodiment of the present disclosure.

### DETAILED DESCRIPTION

The technical solutions in the embodiments of the present disclosure will be described clearly and completely below with reference to the accompanying drawings in the embodiments of the present disclosure. It is apparent that the described embodiments are only a portion of the embodiments of the present disclosure, rather than all of the embodiments. Based on the embodiments in the present disclosure, all other embodiments obtained by those of ordinary skill in the art without creative effort shall fall within the scope of protection of the present disclosure.

It should be noted that if directional indicators (such as up, down, left, right, front, back, etc.) are involved in the embodiments of the present disclosure, the directional indicators are only used to explain the relative positional relationship, movement, etc., between various components in a specific posture. If the specific posture changes, the directional indicators will change accordingly.

In addition, if descriptions involving "first," "second," etc., are involved in the embodiments of the present disclosure, the descriptions of "first," "second," etc., are for descriptive purposes only and should not be understood as indicating or implying their relative importance or implicitly indicating the number of indicated technical features. Thus, a feature defined by "first" or "second" may explicitly or implicitly include at least one such feature. Furthermore, if "and/or" appears in the text, its meaning includes three parallel solutions; taking "A and/or B" as an example, it includes solution A, solution B, or a solution where both A and B are satisfied simultaneously. In addition, the technical solutions between various embodiments can be combined with each other, provided that such combinations are based on what can be realized by those of ordinary skill in the art. When a combination of technical solutions is contradictory or impossible to achieve, such a combination should be considered non-existent and is not within the scope of protection claimed by the present disclosure. If the present disclosure mentions "A includes/comprises B," unless explicitly excluded or not allowed by the context, the inclusion or comprehension therein means that A includes one or more B.

It should be noted that the drawings of the present disclosure are drawn to scale, and the dimensional proportions and relative positions of various components should be considered as part of the disclosure.

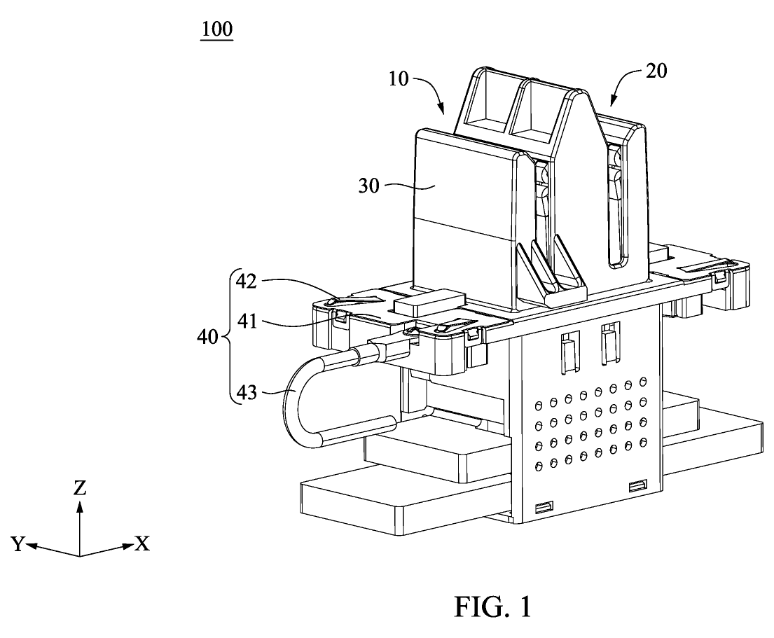

Referring to FIGS. 1 to 3, an electrical connector 100 according to the present disclosure is provided. The electrical connector 100 is configured for providing power to a server. Specifically, the electrical connector 100 is utilized to distribute main power to a server cabinet. To clearly describe the spatial arrangement and structural features of the electrical connector 100, a three-dimensional orthogonal coordinate system is defined herein. The coordinate system includes a lateral direction X, a longitudinal direction Y, and a vertical direction Z, which are mutually perpendicular to one another. The lateral direction X is defined as a left-right direction. The longitudinal direction Y is defined as a front-rear direction (i.e., a direction going into or out of the paper in certain cross-sectional views). The vertical direction Z is defined as an up-down direction, which corresponds to a mating direction or a plugging/unplugging direction of the electrical connector 100 when connected to the server.

In an embodiment, the electrical connector 100 may be configured to connect with various types of Power Distribution Boards (PDBs) to meet different power supply and wiring requirements of the server cabinet. Furthermore, the vertical direction Z may not be strictly limited to the direction of gravity, but can be adjusted according to the actual installation orientation of the server chassis.

In an embodiment, the configuration facilitates the electrical connector 100 to carry a larger current compared to conventional designs having only a single pair of terminal modules. Consequently, this structural arrangement effectively prevents common failures and burnouts of the electrical connector 100 under high-power operating conditions.

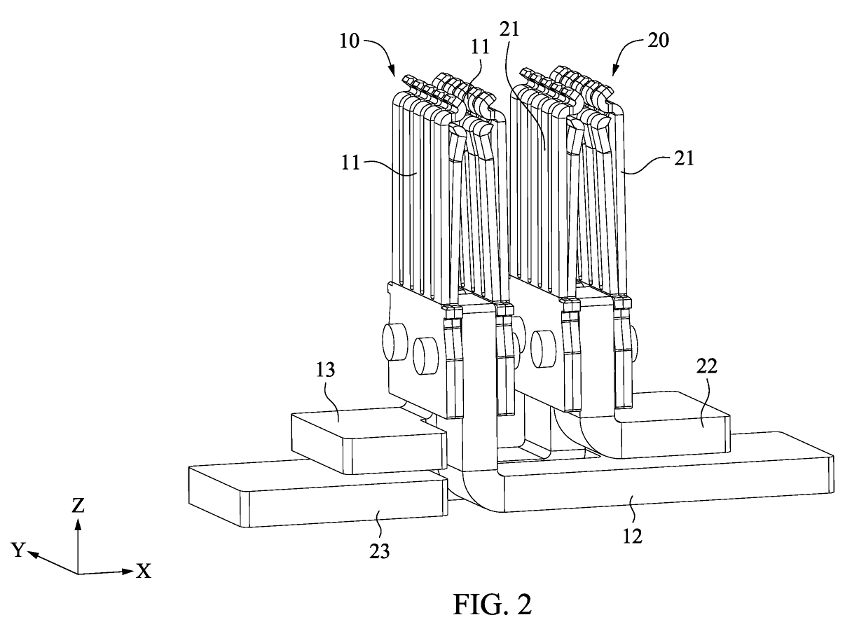

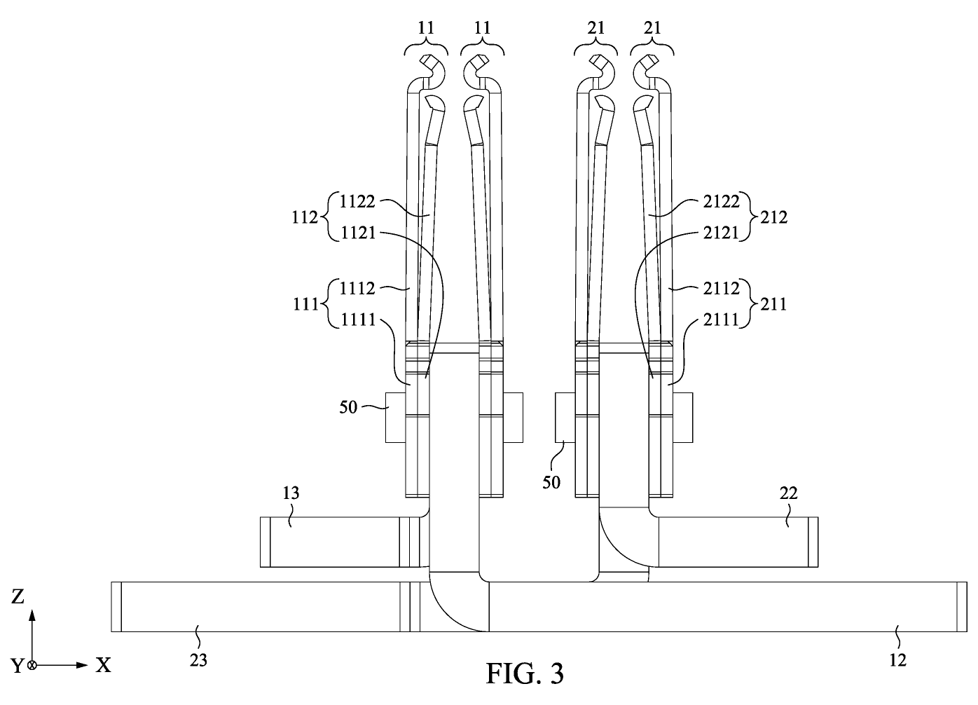

Referring to FIGS. 2 and 3, the electrical connector 100 comprises a positive module 10 and a negative module 20. The positive module 10 and the negative module 20 are spaced apart from each other along the lateral direction X.

The positive module 10 comprises a pair of positive terminal groups 11 spaced apart from each other along the lateral direction X. Each of the positive terminal groups 11 comprises a long terminal 111 and a short terminal 112. Specifically, the long terminal 111 comprises a first fixing plate 1111 and a plurality of first elastic arms 1112 extending from the first fixing plate 1111. The short terminal 112 comprises a second fixing plate 1121 and a plurality of second elastic arms 1122 extending from the second fixing plate 1121. In an embodiment, the long terminal 111 and the short terminal 112 may be formed of highly conductive materials, such as stamped hard copper or soft copper, to ensure optimal electrical conductivity. In an embodiment, the configuration facilitates the positive module 10 to stably connect to a positive joint of the server cabinet through the plurality of first and second elastic arms 1112, 1122, which allows the positive module 10 to carry a larger current reliably.

Similarly, the negative module 20 comprises a pair of negative terminal groups 21 spaced apart from each other along the lateral direction X. Each of the negative terminal groups 21 comprises a long terminal 211 and a short terminal 212. Specifically, the long terminal 211 comprises a first fixing plate 2111 and a plurality of first elastic arms 2112 extending from the first fixing plate 2111. The short terminal 212 comprises a second fixing plate 2121 and a plurality of second elastic arms 2122 extending from the second fixing plate 2121. In an embodiment, similar to the positive module 10, the long terminal 211 and the short terminal 212 of the negative module 20 may be made of stamped copper alloys. In an embodiment, the configuration facilitates the negative module 20 to securely connect to a negative joint of the server cabinet, correspondingly enhancing the overall current-carrying capacity of the electrical connector 100.

Furthermore, the electrical connector 100 comprises a threaded fastener 50. The threaded fastener 50 is configured to structurally fix the pair of positive terminal groups 11 and the respective conductive busbars disposed therebetween as an integrated unit. Likewise, another threaded fastener 50 is utilized to fix the pair of negative terminal groups 21 and the respective conductive busbars disposed therebetween as an integrated unit. In an embodiment, the threaded fastener 50 may be a bolt, a screw, or a similar mechanical fastening element capable of passing through the fixing plates 1111, and 1121 (or the fixing plates 2111 and 2121) to provide a clamping force. In an embodiment, the configuration facilitates tightly sandwiching the conductive busbars between the terminal groups 11, 21, thereby ensuring a low-impedance and low-temperature-rise electrical interface, and preventing the components from loosening during insertion or removal operations.

Referring to FIGS. 2 to 4D, the core spatial layout and geometric features of the conductive busbars are described in detail. For the purpose of description, the side where the positive module 10 is located is defined as the left side, and the side where the negative module 20 is located is defined as the right side. The positive module 10 further comprises a first positive busbar 12 (which is an example of a first conductive busbar, also referred to as a positive-right busbar) and a second positive busbar 13 (which is an example of a second conductive busbar, also referred to as a positive-left busbar). The first positive busbar 12 comprises a first sandwiched portion 121 and a first extending portion 122. The first sandwiched portion 121 is disposed between the pair of positive terminal groups 11. The first extending portion 122 extends along the lateral direction X towards a first side (the right side) of the electrical connector 100. The second positive busbar 13 comprises a second sandwiched portion 131 and a second extending portion 132. The second sandwiched portion 131 is disposed between the pair of positive terminal groups 11, and the second extending portion 132 extends along the lateral direction X towards a second side (the left side) opposite to the first side. Specifically, the first sandwiched portion 121 and the second sandwiched portion 131 are spaced apart from each other between the pair of positive terminal groups 11 along the longitudinal direction Y, wherein the longitudinal direction Y is perpendicular to the lateral direction X.

Similarly, the negative module 20 further comprises a first negative busbar 22 (which is another example of a first conductive busbar, also referred to as a negative-right busbar) and a second negative busbar 23 (which is another example of a second conductive busbar, also referred to as a negative-left busbar). The first negative busbar 22 comprises a third sandwiched portion 221 and a third extending portion 222. The third sandwiched portion 221 is disposed between the pair of negative terminal groups 21, and the third extending portion 222 extends along the lateral direction X towards the first side. The second negative busbar 23 comprises a fourth sandwiched portion 231 and a fourth extending portion 232. The fourth sandwiched portion 231 is disposed between the pair of negative terminal groups 21, and the fourth extending portion 232 extends along the lateral direction X towards the second side. The third sandwiched portion 221 and the fourth sandwiched portion 231 are spaced apart from each other along the longitudinal direction Y.

Regarding the geometric structure, each of the busbars 12, 13, 22, 23 comprises an integrally formed vertical part defining the respective sandwiched portion 121, 131, 221, 231, and a horizontal part defining the respective extending portion 122, 132, 222, 232. Each of the extending portions 122, 132, 222, 232 is positioned below the respective sandwiched portion 121, 131, 221, 231 along the vertical direction Z and is substantially perpendicular to the respective sandwiched portion. To achieve a compact spatial layout, each of the busbars 12, 13, 22, 23 is integrally formed and features a substantially L-shaped configuration, and each of the extending portions 122, 132, 222, 232 is substantially perpendicular to its respective sandwiched portion 121, 131, 221, 231. In an embodiment, the busbars 12, 13, 22, 23 may be formed by a stamping and bending process such that each extending portion is bent to be perpendicular to the respective sandwiched portion, thereby forming a right angle at the bending interface and ensuring structural integrity and material continuity.

In an embodiment, the first, second, third, and fourth busbars 12, 13, 22, 23 may be integrally formed of hard copper or soft copper, and the aforementioned right angle configuration may be formed by a parallel bending process.

In an embodiment, the configuration facilitates spacing the respective sandwiched portions apart along the longitudinal direction Y to effectively prevent short circuits. Furthermore, sandwiching two busbars side-by-side between the respective terminal groups provides a low-impedance and low-temperature-rise electrical path. Most importantly, by arranging the sandwiched portions 121, 131 (or the sandwiched portions 221, 231) along the longitudinal direction Y while directing the extending portions 122, 132 (or the extending portions 222, 232) along the perpendicular lateral direction X, the configuration facilitates significantly minimizing the distance between the pair of terminal groups 11 (or the pair of terminal groups 21). This orthogonal layout effectively reduces the overall volume and width of the electrical connector 100, successfully overcoming the bulky footprint commonly seen in conventional designs where busbars are arranged laterally between the terminals.

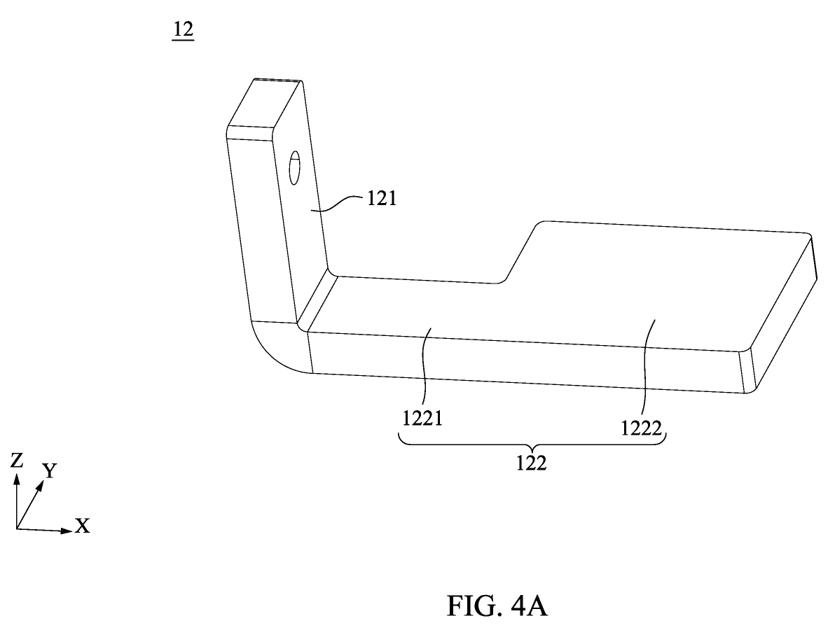

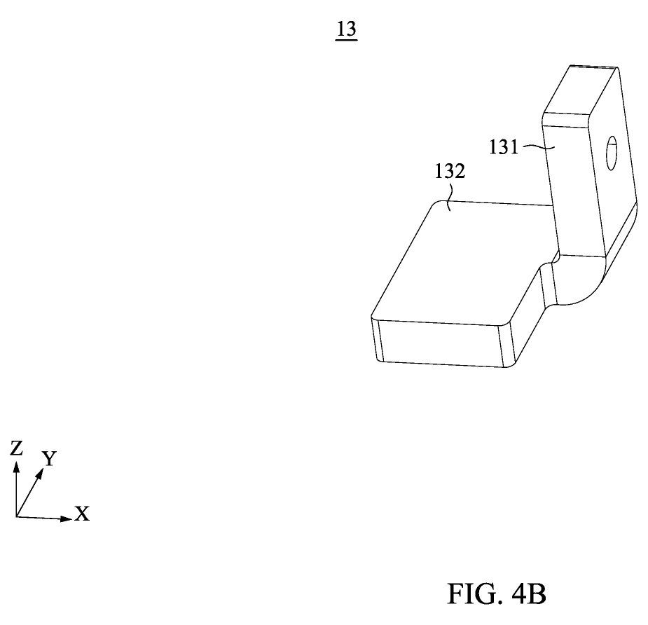

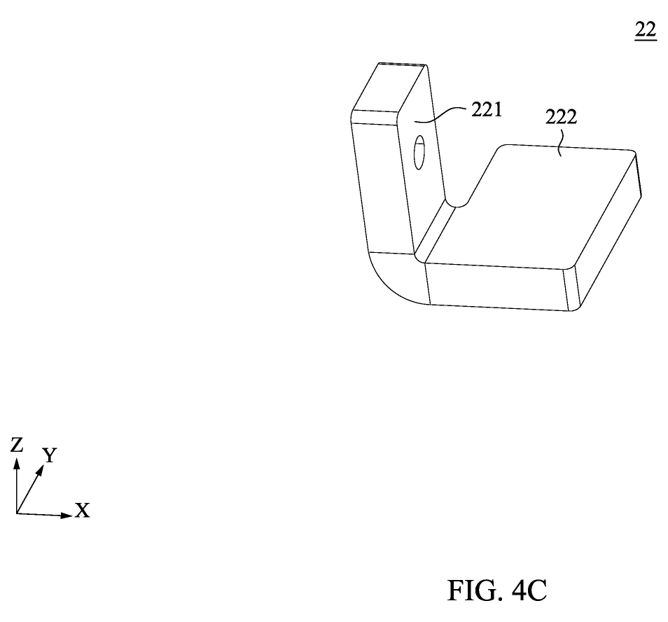

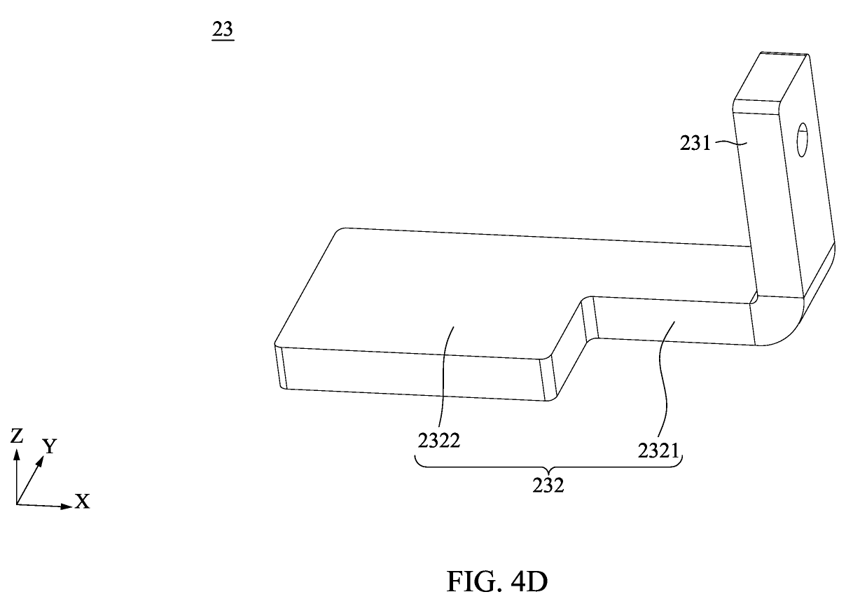

Referring to FIGS. 3 and 4A to 4D, the staggered arrangement, clearance, and alignment configuration of the extending portions of the busbars are further detailed. Structurally, the second extending portion 132 of the second positive busbar 13 and the third extending portion 222 of the first negative busbar 22 are located on a first horizontal plane. Conversely, the first extending portion 122 of the first positive busbar 12 and the fourth extending portion 232 of the second negative busbar 23 are located on a second horizontal plane different from the first horizontal plane. To maintain a neat configuration, opposite edges of the second extending portion 132 along the longitudinal direction Y are substantially aligned with opposite edges of the third extending portion 222 along the longitudinal direction Y.

In an embodiment, the first horizontal plane and the second horizontal plane may be spaced apart vertically with a predetermined distance to accommodate distinct wiring paths for external cables. In an embodiment, the configuration facilitates staggering the busbars in the vertical direction Z, which significantly reduces the crossing of electrical wires and keeps the electrical connector 100 much neater. This staggered arrangement is also consistent with the PDB (Power Distribution Board) outgoing line arrangement, making the wiring process much more convenient.

Furthermore, to optimize the internal space, the first extending portion 122 comprises a connection part 1221 and a contact part 1222 for electrical connection. The connection part 1221 connects the first sandwiched portion 121 to the contact part 1222. Similarly, the fourth extending portion 232 comprises a connection part 2321 and a contact part 2322 for electrical connection. The connection part 2321 connects the fourth sandwiched portion 231 to the contact part 2322. Specifically, opposite edges of the contact part 1222 of the first extending portion 122 along the longitudinal direction Y are substantially aligned with opposite edges of the contact part 2322 of the fourth extending portion 232 along the longitudinal direction Y. A width of the contact part 1222 along the longitudinal direction Y is greater than a width of the connection part 1221 along the longitudinal direction Y. Likewise, a width of the contact part 2322 along the longitudinal direction Y is greater than a width of the connection part 2321 along the longitudinal direction Y. The connection part 1221 of the first extending portion 122 provides clearance for the connection part 2321 of the fourth extending portion 232, making a combined width of the connection part 1221 and the connection part 2321 along the longitudinal direction Y substantially correspond to a width of any one of the contact parts 1222, 2322 along the longitudinal direction Y. In an embodiment, the combined width of the connection part 1221 and the connection part 2321 along the longitudinal direction Y is no greater than the width of any one of the contact parts 1222, 2322 along the longitudinal direction Y.

In an embodiment, the connection parts 1221, 2321 may be formed by cutting or stamping a side of the respective extending portions to precisely create the necessary clearance space. In an embodiment, the configuration facilitates the connection part 1221 yielding space to the adjacent connection part 2321, ensuring that the combined width of the first positive busbar 12 and the second negative busbar 23 does not exceed a width of the respective terminal groups. This structural ingenuity effectively makes the electrical connector 100 overall more miniaturized and lightweight.

Moreover, a width of the second extending portion 132 is substantially equal to a width of the contact part 2322 of the fourth extending portion 232 along the longitudinal direction Y. Opposite edges of the second extending portion 132 along the longitudinal direction Y are substantially aligned with opposite edges of the contact part 2322 along the longitudinal direction Y. In addition, central axes of the second extending portion 132 and the contact part 2322 are located within a same vertical plane. Likewise, a width of the third extending portion 222 is substantially equal to a width of the contact part 1222 of the first extending portion 122 along the longitudinal direction Y. Opposite edges of the third extending portion 222 along the longitudinal direction Y are substantially aligned with opposite edges of the contact part 1222 along the longitudinal direction Y. In addition, central axes of the third extending portion 222 and the contact part 1222 are located within a same vertical plane.

In an embodiment, the extending portions and the corresponding contact parts located on the same lateral side may be manufactured with identical width profiles to maintain a balanced current distribution. In an embodiment, the configuration facilitates aligning the opposite edges of the vertically staggered busbars on the same lateral side, which makes the layout of the busbars more reasonable and concise. This effective alignment further contributes to the overall miniaturization and lightweight design of the electrical connector 100.

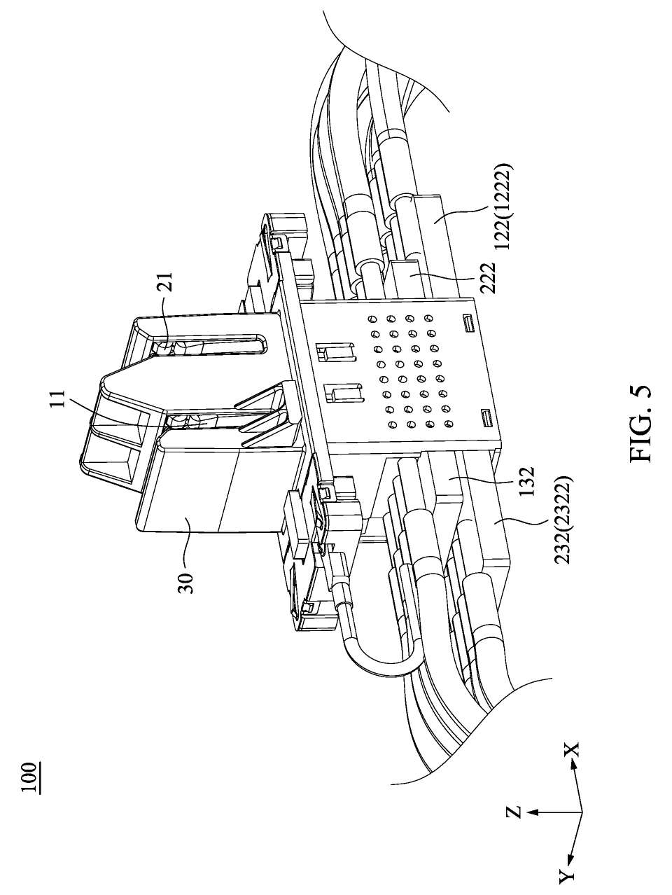

Referring to FIGS. 1 and 5, the overall architecture, insulation, and grounding system of the electrical connector 100 are described. The electrical connector 100 further comprises an insulating housing 30. The pair of positive terminal groups 11 and the pair of negative terminal groups 21 are disposed within the insulating housing 30. The extending portions 122, 132, 222, 232 of the busbars are exposed outside the insulating housing 30. Furthermore, the electrical connector 100 comprises a ground terminal 40. The ground terminal 40 comprises a main body 41 and an elastic arm 42. The main body 41 is connected to the insulating housing 30. One end of the elastic arm 42 is connected to the main body 41, and another end of the elastic arm 42 is configured to abut against a chassis of the server. The ground terminal 40 further comprises a ground wire 43. One end of the ground wire 43 is connected to the main body 41, and another end of the ground wire 43 is grounded.

In an embodiment, the insulating housing 30 may be made of insulating materials, such as hard plastic or hard rubber. The ground terminal 40 may be made of copper or stainless steel materials. The connection between the ground wire 43 and the main body 41 may be secured by a threaded screw. Specifically, the threaded screw may pass through the one end of the ground wire 43 and the main body 41 to synchronously fix both to the insulating housing 30. Alternatively, the connection between the ground wire 43 and the main body 41 may be achieved by welding or riveting.

In an embodiment, the configuration facilitates the insulating housing 30 preventing the positive and negative terminal groups 11, 21 from directly or indirectly contacting each other, thereby avoiding electrical short circuits. Furthermore, the configuration facilitates the elastic arm 42 automatically abutting the server chassis when the electrical connector 100 is inserted into the server cabinet, effectively conducting stray currents to the chassis and safely routing excess current to the ground via the ground wire 43.

Referring to FIG. 5, the external wiring is provided. The contact parts 1222, 2322, as well as the second extending portion 132 and the third extending portion 222, are configured to connect to external electrical wires. Specifically, the second extending portion 132 of the second positive busbar 13 and the fourth extending portion 232 of the second negative busbar 23 located on the left side are connected to a first joint via the external electrical wires, while the first extending portion 122 of the first positive busbar 12 and the third extending portion 222 of the first negative busbar 22 located on the right side are connected to a second joint via the external electrical wires, so as to respectively form distinct current loops. A heat-shrinkable sleeve may be disposed at a connection interface between the extending portions and the external electrical wires.

In an embodiment, the connection between the extending portions and the electrical wires may be achieved via welding or riveting. The right-angle layout with parallel extending portions provides a flat structural surface for electrical coupling.

In an embodiment, the configuration facilitates the heat-shrinkable sleeve protecting the connection interface from physical damage or water ingress, which effectively prevents connection failures of the electrical connector 100. Moreover, the parallel bending design facilitates increasing the welding surface area, thereby significantly enhancing the connection strength.

Overall, the configuration facilitates the electrical connector 100 achieving several superior advantages in some embodiments. First, utilizing spaced pairs of terminal groups is intended to allow the electrical connector 100 to carry a significantly larger current. Second, sandwiching the busbars side-by-side between the terminal groups may facilitate providing a low-impedance and low-temperature-rise electrical path. Third, spacing the sandwiched portions apart in the longitudinal direction Y is configured to potentially prevent short circuits. Fourth, arranging the staggered extending portions to extend along the lateral direction X ensures consistency with a PDB (Power Distribution Board) outgoing line arrangement, potentially making the wiring process much more convenient and organized. Finally, the aforementioned orthogonal geometric layout features simple processing and assembly, which may effectively reduce manufacturing costs while achieving a highly miniaturized and lightweight footprint.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. An electrical connector for providing power to a server, comprising:
a positive module and a negative module spaced apart from each other along a lateral direction, the positive module comprising:
a pair of positive terminal groups spaced apart from each other along the lateral direction;
a first positive busbar comprising a first sandwiched portion and a first extending portion, the first sandwiched portion being disposed between the pair of positive terminal groups, and the first extending portion extending along the lateral direction towards a first side of the electrical connector; and
a second positive busbar comprising a second sandwiched portion and a second extending portion, the second sandwiched portion being disposed between the pair of positive terminal groups, and the second extending portion extending along the lateral direction towards a second side opposite to the first side;
wherein the first sandwiched portion and the second sandwiched portion are spaced apart from each other along a longitudinal direction perpendicular to the lateral direction; and
wherein the negative module comprises a pair of negative terminal groups spaced apart from each other along the lateral direction.

2. The electrical connector of claim 1, wherein the negative module further comprises:
a first negative busbar comprising a third sandwiched portion and a third extending portion, the third sandwiched portion being disposed between the pair of negative terminal groups, and the third extending portion extending along the lateral direction towards the first side; and
a second negative busbar comprising a fourth sandwiched portion and a fourth extending portion, the fourth sandwiched portion being disposed between the pair of negative terminal groups, and the fourth extending portion extending along the lateral direction towards the second side;
wherein the third sandwiched portion and the fourth sandwiched portion are spaced apart from each other along the longitudinal direction.

3. The electrical connector of claim 2, wherein each of the extending portions is positioned below the respective sandwiched portion along a vertical direction perpendicular to both the lateral direction and the longitudinal direction, and wherein each of the extending portions is substantially perpendicular to the respective sandwiched portion.

4. The electrical connector of claim 3, wherein the second extending portion and the third extending portion are located on a first horizontal plane.

5. The electrical connector of claim 4, wherein the first extending portion and the fourth extending portion are located on a second horizontal plane different from the first horizontal plane.

6. The electrical connector of claim 3, wherein opposite edges of the second extending portion along the longitudinal direction are substantially aligned with opposite edges of the third extending portion along the longitudinal direction.

7. The electrical connector of claim 3, wherein the first extending portion and the fourth extending portion each comprises a connection part and a contact part for electrical connection, the connection part connecting the respective sandwiched portion to the contact part.

8. The electrical connector of claim 7, wherein opposite edges of the contact part of the first extending portion along the longitudinal direction are substantially aligned with opposite edges of the contact part of the fourth extending portion along the longitudinal direction.

9. The electrical connector of claim 7, wherein a width of the contact part along the longitudinal direction is greater than a width of the connection part along the longitudinal direction.

10. The electrical connector of claim 9, wherein the connection part of the first extending portion provides clearance for the connection part of the fourth extending portion, making a combined width of the connection part and the connection part along the longitudinal direction substantially corresponds to a width of any one of the contact parts along the longitudinal direction.

11. The electrical connector of claim 7, wherein a width of the second extending portion is substantially equal to a width of the contact part of the fourth extending portion along the longitudinal direction, and
wherein opposite edges of the second extending portion along the longitudinal direction are substantially aligned with opposite edges of the contact part along the longitudinal direction.

12. The electrical connector of claim 7, wherein a width of the third extending portion is substantially equal to a width of the contact part of the first extending portion along the longitudinal direction, and
wherein opposite edges of the third extending portion along the longitudinal direction are substantially aligned with opposite edges of the contact part along the longitudinal direction.

13. The electrical connector of claim 7, wherein the contact parts are configured to connect to electrical wires via welding or riveting, and wherein a heat-shrinkable sleeve is disposed at a connection interface.

14. The electrical connector of claim 2, further comprising:
an insulating housing, wherein the pair of positive terminal groups and the pair of negative terminal groups are disposed within the insulating housing, and the extending portions of the busbars are exposed outside the insulating housing.

15. The electrical connector of claim 14, further comprising:
a ground terminal comprising a main body connected to the insulating housing and an elastic arm having one end connected to the main body and another end configured to abut against a chassis of the server.

16. The electrical connector of claim 15, wherein the ground terminal further comprises a ground wire having one end connected to the main body and another end grounded.

17. The electrical connector of claim 1, wherein each of the positive terminal groups and the negative terminal groups comprises a long terminal and a short terminal, and
wherein the long terminal comprises a first fixing plate and a plurality of first elastic arms extending from the first fixing plate, and the short terminal comprises a second fixing plate and a plurality of second elastic arms extending from the second fixing plate.

18. The electrical connector of claim 2, wherein the second extending portion and the third extending portion are positioned within a first horizontal plane perpendicular to a vertical direction perpendicular to both the lateral direction and the longitudinal direction, and the first extending portion and the fourth extending portion are positioned within a second horizontal plane perpendicular to the vertical direction, the second horizontal plane being different from the first horizontal plane.

19. The electrical connector of claim 1, further comprising a threaded fastener configured to fix the pair of positive terminal groups and the respective sandwiched portions disposed therebetween as an integrated unit.

20. An electrical connector for providing power to a server, comprising:
at least one module comprising:
a pair of terminal groups spaced apart from each other along a lateral direction;
a first conductive busbar comprising a first sandwiched portion and a first extending portion, the first sandwiched portion being disposed between the pair of terminal groups, and the first extending portion extending along the lateral direction towards a first side of the electrical connector; and
a second conductive busbar comprising a second sandwiched portion and a second extending portion, the second sandwiched portion being disposed between the pair of terminal groups, and the second extending portion extending along the lateral direction towards a second side opposite to the first side;
wherein the first sandwiched portion and the second sandwiched portion are spaced apart from each other between the pair of terminal groups along a longitudinal direction, the longitudinal direction being perpendicular to the lateral direction.
